(19) United States
(12) Patent Application Publication
(10) Pub. No.: US 2014/0087321 A1
(43) Pub. Date: Mar. 27, 2014

(54) ACTIVE COOLING REGULATION OF INDUCTION MELT PROCESS

(71) Applicants: THEODORE A. WANIUK, Lake Forest, CA (US); Joseph Stevick, Glendora, CA (US); Sean O'Keeffe, San Francisco, CA (US); Dermot J. Stratton, San Francisco, CA (US); Joseph C. Poole, San Francisco, CA (US); Matthew S. Scott, Campbell, CA (US); Christopher D. Prest, San Francisco, CA (US)

(72) Inventors: THEODORE A. WANIUK, Lake Forest, CA (US); Joseph Stevick, Glendora, CA (US); Sean O'Keeffe, San Francisco, CA (US); Dermot J. Stratton, San Francisco, CA (US); Joseph C. Poole, San Francisco, CA (US); Matthew S. Scott, Campbell, CA (US); Christopher D. Prest, San Francisco, CA (US)

(21) Appl. No.: 13/628,573

(22) Filed: Sep. 27, 2012

(51) Int. Cl. F27D 9/00

(52) U.S. Cl. CPC F27D 9/00
USPC 432/13; 432/48

(57) ABSTRACT

Various embodiments provide methods and apparatus for active cooling regulation of a melting process. In one embodiment, a meltable material can be melted in a vessel that includes cooling channel(s) configured therein. A contact temperature T_{Contact} of the vessel at an interface with the melt can be measured and compared with a skull forming temperature T_{Skull} and a wetting temperature T_{Wetting} of the melt on the vessel. A cooling rate can be regulated to regulate T_{Contact} to be T_{Skull}<T_{Contact}<T_{Wetting}. In another embodiment, T_{Contact} can be regulated in a value close or equal to a wetting threshold temperature T_{Th-I}, wherein T_{TH-I}=T_{Wetting}—a temperature safety margin for T_{Wetting}. In yet another embodiment, T_{Contact} can be regulated such that T_{Th-II}≦T_{Contact}≦T_{Th-I}, wherein T_{Th-II}=T_{Skull} plus a temperature safety margin for T_{Skull}.

### FIELD OF THE INVENTION

The present embodiments relate to methods and apparatus for melting processes. The present embodiments also relate to methods and apparatus for active cooling regulation of a melting process.

### BACKGROUND

When melting a metal alloy, the metal alloy is placed on copper boat. Both the metal alloy and the copper boat are heated up simultaneously. The metal alloy and the copper boat may then fuse and alloy with each other and finally destroy the copper boat and the produced article. To solve this problem, the copper boat is often water cooled to reduce or prevent interact between the metal alloy and the copper boat at high temperatures. Problems arise, however, because the cooled molten alloy boat then needs more energy to be heated up, which provides low process efficiency. In addition, heat leakage may occur during conventional melting process, when the metal alloy is inductively melted and when the molten alloy is transferred to a casting device.

It is desirable to have metal alloy melted at high temperatures having high superheat but without reaching the temperature that the molten alloy wets and fuses with the copper boat. It is also desirable not to form a skull layer as in the conventional melting process and to increase the process efficiency of the melting cycle.

### SUMMARY

A proposed solution according to embodiments herein for melting meltable materials (e.g., metals or metal alloys), in a vessel is to control the temperature at an interface or contact point between the meltable material and the vessel by an active cooling regulation.

In accordance with various embodiments, there is provided a method of active cooling regulation of a melting process. A meltable material can be melted in a vessel that includes at least one cooling channel configured therein. A contact temperature T_{Contact} of the vessel at in contact with the melt can be measured and compared with a skull forming temperature T_{Skull} and a wetting temperature T_{Wetting} of the melt to wet the vessel. A cooling rate in the cooling channel(s) can then be regulated such that T_{Skull}<T_{Contact}<T_{Wetting}.

In accordance with various embodiments, there is provided a method of active cooling regulation of a melting process. A meltable material can be melted in a vessel that includes at least one cooling channel configured therein. The contact temperature T_{Contact} of the vessel at in contact with the melt can be measured and compared with a wetting threshold temperature T_{Th-I}, wherein T_{Th-I}=T_{Wetting}−T_{sm-I}, and T_{sm-I} is a temperature safety margin for T_{Wetting}. A cooling rate in the at least one cooling channel can then be regulated such that T_{Contact} is a value close to T_{Th-I}.

In accordance with various embodiments, there is provided a method of active cooling regulation of a melting process. A meltable material can be melted in a vessel that includes at least one cooling channel configured therein. A contact temperature T_{Contact} of the vessel at an interface with the melt can be measured and compared with one or both of a wetting threshold temperature T_{Th-I} and a skull forming threshold temperature T_{Th-II}, wherein T_{Th-I}=T_{Wetting}−T_{sm-I}, and T_{sm-I} is a temperature safety margin for T_{Wetting}, and T_{Th-II}=T_{Skull}+T_{sm-II}, T_{sm-II} is a temperature safety margin for T_{Skull}. A cooling rate can then be regulated in the at least one cooling channel such that T_{Th-II}≦T_{Contact}≦T_{TH-I}.

In accordance with various embodiments, there is provided a melting system with active cooling regulation. The melting system can include a heating component configured to heat a meltable material in a vessel; a cooling component configured to include a cooling controller and a cooling channel; and a thermal sensor configured to measure a contact temperature T_{Contact} at an interface between the heated meltable material and the vessel. The cooling channel can be configured to flow a coolant therein.

In accordance with various embodiments, there is provided an apparatus of active cooling regulation of a melting process. The apparatus can include a computer and a melting system. The melting system can include a heating component configured to heat a meltable material in a vessel, a cooling component including a cooling controller and configured to flow a coolant therein, and a thermal sensor configured to measure contact temperature T_{Contact} between the heated meltable material and the vessel. The computer compares T_{Contact} with one or more of a skull forming temperature of T_{Skull}, a wetting temperature T_{Wetting}, a wetting threshold temperature T_{Th-I}, and a skull forming threshold temperature T_{Th-II} for regulating a cooling rate in the cooling component.

In accordance with various embodiments, a coolant flow rate can be regulated to regulate the temperature such as T_{Contact} in an inline melting system or other types of melting systems. If a coolant such as a cooling water is actively controlled, the melt overheat can be increased during the melting cycle by reducing the cooling rate of a vessel (e.g., boat, crucible, container, etc.) that contains the melt. Alternatively, the cooling can be turned off for a short duration during the melting cycle to maximize overheat of the melt. After the melt is processed, the cooling can be increased to prevent surfaces which may still contain hot alloy from reacting excessively with atmospheric contaminants in the chamber containing the vessel.

### BRIEF DESCRIPTION OF THE DRAWINGS

FIG. 1 provides a temperature-viscosity diagram of an exemplary bulk solidifying amorphous alloy.

FIG. 2 provides a schematic of a time-temperature-transformation (TTT) diagram for an exemplary bulk solidifying amorphous alloy.

FIGS. 3a-3b depict various exemplary melting systems in accordance with various embodiments of the present teachings.

FIGS. 4a-4c depict temperature controls during active cooling regulation of a melting process in accordance with various embodiments of the present teachings.

FIGS. 5a-5c depict various exemplary methods of active cooling regulation of a melting process in accordance with various embodiments of the present teachings.

FIG. 6 depicts an apparatus for active cooling regulation of a melting process in accordance with various embodiments of the present teachings.

### DETAILED DESCRIPTION

All publications, patents, and patent applications cited in this Specification are hereby incorporated by reference in their entirety.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. Amorphous alloys have many superior properties than their crystalline counterparts. However, if the cooling rate is not sufficiently high, crystals may form inside the alloy during cooling, so that the benefits of the amorphous state can be lost. For example, one challenge with the fabrication of bulk amorphous alloy parts is partial crystallization of the parts due to either slow cooling or impurities in the raw alloy material. As a high degree of amorphicity (and, conversely, a low degree of crystallinity) is desirable in BMG parts, there is a need to develop methods for casting BMG parts having controlled amount of amorphicity.

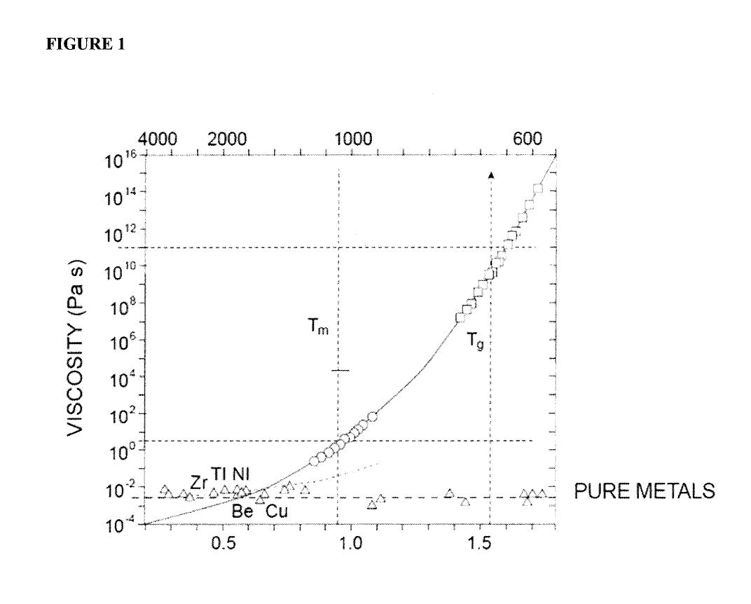

FIG. 1 (obtained from U.S. Pat. No. 7,575,040) shows a viscosity-temperature graph of an exemplary bulk solidifying amorphous alloy, from the VIT-001 series of Zr—Ti—Ni—Cu—Be family manufactured by Liquidmetal Technology. It should be noted that there is no clear liquid/solid transformation for a bulk solidifying amorphous metal during the formation of an amorphous solid. The molten alloy becomes more and more viscous with increasing undercooling until it approaches solid form around the glass transition temperature. Accordingly, the temperature of solidification front for bulk solidifying amorphous alloys can be around glass transition temperature, where the alloy will practically act as a solid for the purposes of pulling out the quenched amorphous sheet product.

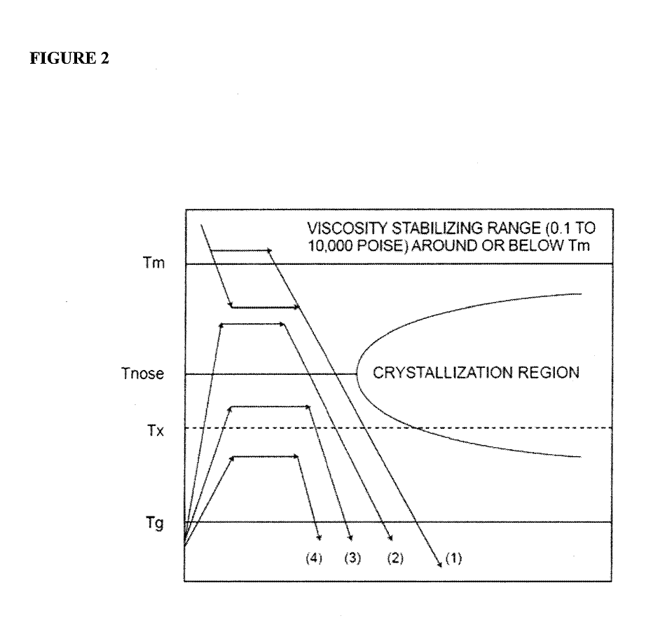

FIG. 2 (obtained from U.S. Pat. No. 7,575,040) shows the time-temperature-transformation (TTT) cooling curve of an exemplary bulk solidifying amorphous alloy, or TTT diagram. Bulk-solidifying amorphous metals do not experience a liquid/solid crystallization transformation upon cooling, as with conventional metals. Instead, the highly fluid, non-crystalline form of the metal found at high temperatures (near a “melting temperature” Tm) becomes more viscous as the temperature is reduced (near to the glass transition temperature Tg), eventually taking on the outward physical properties of a conventional solid.

Even though there is no liquid/crystallization transformation for a bulk solidifying amorphous metal, a “melting temperature” Tm may be defined as the thermodynamic liquidus temperature of the corresponding crystalline phase. Under this regime, the viscosity of bulk-solidifying amorphous alloys at the melting temperature could lie in the range of about 0.1 poise to about 10,000 poise, and even sometimes under 0.01 poise. A lower viscosity at the “melting temperature” would provide faster and complete filling of intricate portions of the shell/mold with a bulk solidifying amorphous metal for forming the BMG parts. Furthermore, the cooling rate of the molten metal to form a BMG part has to such that the time-temperature profile during cooling does not traverse through the nose-shaped region bounding the crystallized region in the TTT diagram of FIG. 2. In FIG. 2, Tnose is the critical crystallization temperature Tx where crystallization is most rapid and occurs in the shortest time scale.

The supercooled liquid region, the temperature region between Tg and Tx is a manifestation of the extraordinary stability against crystallization of bulk solidification alloys. In this temperature region the bulk solidifying alloy can exist as a high viscous liquid. The viscosity of the bulk solidifying alloy in the supercooled liquid region can vary between 10¹² Pa s at the glass transition temperature down to 10⁵ Pa s at the crystallization temperature, the high temperature limit of the supercooled liquid region. Liquids with such viscosities can undergo substantial plastic strain under an applied pressure. The embodiments herein make use of the large plastic formability in the supercooled liquid region as a forming and separating method.

One needs to clarify something about Tx. Technically, the nose-shaped curve shown in the TTT diagram describes Tx as a function of temperature and time. Thus, regardless of the trajectory that one takes while heating or cooling a metal alloy, when one hits the TTT curve, one has reached Tx. In FIG. 2, Tx is shown as a dashed line as Tx can vary from close to Tm to close to Tg.

The schematic TTT diagram of FIG. 2 shows processing methods of die casting from at or above Tm to below Tg without the time-temperature trajectory (shown as (1) as an example trajectory) hitting the TTT curve. During die casting, the forming takes place substantially simultaneously with fast cooling to avoid the trajectory hitting the TTT curve. The processing methods for superplastic forming (SPF) from at or below Tg to below Tm without the time-temperature trajectory (shown as (2), (3) and (4) as example trajectories) hitting the TTT curve. In SPF, the amorphous BMG is reheated into the supercooled liquid region where the available processing window could be much larger than die casting, resulting in better controllability of the process. The SPF process does not require fast cooling to avoid crystallization during cooling. Also, as shown by example trajectories (2), (3) and (4), the SPF can be carried out with the highest temperature during SPF being above Tnose or below Tnose, up to about Tm. If one heats up a piece of amorphous alloy but manages to avoid hitting the TTT curve, you have heated “between Tg and Tm”, but one would have not reached Tx.

Typical differential scanning calorimeter (DSC) heating curves of bulk-solidifying amorphous alloys taken at a heating rate of 20 C/min describe, for the most part, a particular trajectory across the TTT data where one would likely see a Tg at a certain temperature, a Tx when the DSC heating ramp crosses the TTT crystallization onset, and eventually melting peaks when the same trajectory crosses the temperature range for melting. If one heats a bulk-solidifying amorphous alloy at a rapid heating rate as shown by the ramp up portion of trajectories (2), (3) and (4) in FIG. 2, then one could avoid the TTT curve entirely, and the DSC data would show a glass transition but no Tx upon heating. Another way to think about it is trajectories (2), (3) and (4) can fall anywhere in temperature between the nose of the TTT curve (and even above it) and the Tg line, as long as it does not hit the crystallization curve. That just means that the horizontal plateau in trajectories might get much shorter as one increases the processing temperature.

### Phase

The term “phase” herein can refer to one that can be found in a thermodynamic phase diagram. A phase is a region of space (e.g., a thermodynamic system) throughout which all physical properties of a material are essentially uniform. Examples of physical properties include density, index of refraction, chemical composition and lattice periodicity. A simple description of a phase is a region of material that is chemically uniform, physically distinct, and/or mechanically separable. For example, in a system consisting of ice and water in a glass jar, the ice cubes are one phase, the water is a second phase, and the humid air over the water is a third phase. The glass of the jar is another separate phase. A phase can refer to a solid solution, which can be a binary, tertiary, quaternary, or more, solution, or a compound, such as an intermetallic compound. As another example, an amorphous phase is distinct from a crystalline phase.

### Metal, Transition Metal, and Non-Metal

The term “metal” refers to an electropositive chemical element. The term “element” in this Specification refers generally to an element that can be found in a Periodic Table. Physically, a metal atom in the ground state contains a partially filled band with an empty state close to an occupied state. The term “transition metal” is any of the metallic elements within Groups 3 to 12 in the Periodic Table that have an incomplete inner electron shell and that serve as transitional links between the most and the least electropositive in a series of elements. Transition metals are characterized by multiple valences, colored compounds, and the ability to form stable complex ions. The term “nonmetal” refers to a chemical element that does not have the capacity to lose electrons and form a positive ion.

Depending on the application, any suitable nonmetal elements, or their combinations, can be used. The alloy (or “alloy composition”) can comprise multiple nonmetal elements, such as at least two, at least three, at least four, or more, nonmetal elements. A nonmetal element can be any element that is found in Groups 13-17 in the Periodic Table. For example, a nonmetal element can be any one of F, Cl, Br, I, At, O, S, Se, Te, Po, N, P, As, Sb, Bi, C, Si, Ge, Sn, Pb, and B. Occasionally, a nonmetal element can also refer to certain metalloids (e.g., B, Si, Ge, As, Sb, Te, and Po) in Groups 13-17. In one embodiment, the nonmetal elements can include B, Si, C, P, or combinations thereof. Accordingly, for example, the alloy can comprise a boride, a carbide, or both.

A transition metal element can be any of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, ununnilium, unununium, and ununbium. In one embodiment, a BMG containing a transition metal element can have at least one of Sc, Y, La, Ac, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, and Hg. Depending on the application, any suitable transitional metal elements, or their combinations, can be used. The alloy composition can comprise multiple transitional metal elements, such as at least two, at least three, at least four, or more, transitional metal elements.

The presently described alloy or alloy “sample” or “specimen” alloy can have any shape or size. For example, the alloy can have a shape of a particulate, which can have a shape such as spherical, ellipsoid, wire-like, rod-like, sheet-like, flake-like, or an irregular shape. The particulate can have any size. For example, it can have an average diameter of between about 1 micron and about 100 microns, such as between about 5 microns and about 80 microns, such as between about 10 microns and about 60 microns, such as between about 15 microns and about 50 microns, such as between about 15 microns and about 45 microns, such as between about 20 microns and about 40 microns, such as between about 25 microns and about 35 microns. For example, in one embodiment, the average diameter of the particulate is between about 25 microns and about 44 microns. In some embodiments, smaller particulates, such as those in the nanometer range, or larger particulates, such as those bigger than 100 microns, can be used.

The alloy sample or specimen can also be of a much larger dimension. For example, it can be a bulk structural component, such as an ingot, housing/casing of an electronic device or even a portion of a structural component that has dimensions in the millimeter, centimeter, or meter range.

### Solid Solution

The term “solid solution” refers to a solid form of a solution. The term “solution” refers to a mixture of two or more substances, which may be solids, liquids, gases, or a combination of these. The mixture can be homogeneous or heterogeneous. The term “mixture” is a composition of two or more substances that are combined with each other and are generally capable of being separated. Generally, the two or more substances are not chemically combined with each other.

### Alloy

In some embodiments, the alloy composition described herein can be fully alloyed. In one embodiment, an “alloy” refers to a homogeneous mixture or solid solution of two or more metals, the atoms of one replacing or occupying interstitial positions between the atoms of the other; for example, brass is an alloy of zinc and copper. An alloy, in contrast to a composite, can refer to a partial or complete solid solution of one or more elements in a metal matrix, such as one or more compounds in a metallic matrix. The term alloy herein can refer to both a complete solid solution alloy that can give single solid phase microstructure and a partial solution that can give two or more phases. An alloy composition described herein can refer to one comprising an alloy or one comprising an alloy-containing composite.

Thus, a fully alloyed alloy can have a homogenous distribution of the constituents, be it a solid solution phase, a compound phase, or both. The term “fully alloyed” used herein can account for minor variations within the error tolerance. For example, it can refer to at least 90% alloyed, such as at least 95% alloyed, such as at least 99% alloyed, such as at least 99.5% alloyed, such as at least 99.9% alloyed. The percentage herein can refer to either volume percent or weight percentage, depending on the context. These percentages can be balanced by impurities, which can be in terms of composition or phases that are not a part of the alloy.

### Amorphous or Non-Crystalline Solid

An “amorphous” or “non-crystalline solid” is a solid that lacks lattice periodicity, which is characteristic of a crystal. As used herein, an “amorphous solid” includes “glass” which is an amorphous solid that softens and transforms into a liquid-like state upon heating through the glass transition. Generally, amorphous materials lack the long-range order characteristic of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

The terms “order” and “disorder” designate the presence or absence of some symmetry or correlation in a many-particle system. The terms “long-range order” and “short-range order” distinguish order in materials based on length scales.

The strictest form of order in a solid is lattice periodicity: a certain pattern (the arrangement of atoms in a unit cell) is repeated again and again to form a translationally invariant tiling of space. This is the defining property of a crystal. Possible symmetries have been classified in 14 Bravais lattices and 230 space groups.

Lattice periodicity implies long-range order. If only one unit cell is known, then by virtue of the translational symmetry it is possible to accurately predict all atomic positions at arbitrary distances. The converse is generally true, except, for example, in quasi-crystals that have perfectly deterministic tilings but do not possess lattice periodicity.

Long-range order characterizes physical systems in which remote portions of the same sample exhibit correlated behavior. This can be expressed as a correlation function, namely the spin-spin correlation function: G(x,x′)= [symbol] (s(x), s(x′) [symbol] .

In the above function, s is the spin quantum number and x is the distance function within the particular system. This function is equal to unity when x=x′ and decreases as the distance |x−x′| increases. Typically, it decays exponentially to zero at large distances, and the system is considered to be disordered. If, however, the correlation function decays to a constant value at large |x−x′|, then the system can be said to possess long-range order. If it decays to zero as a power of the distance, then it can be called quasi-long-range order. Note that what constitutes a large value of |x−x′| is relative.

A system can be said to present quenched disorder when some parameters defining its behavior are random variables that do not evolve with time (i.e., they are quenched or frozen)—e.g., spin glasses. It is opposite to annealed disorder, where the random variables are allowed to evolve themselves. Embodiments herein include systems comprising quenched disorder.

The alloy described herein can be crystalline, partially crystalline, amorphous, or substantially amorphous. For example, the alloy sample/specimen can include at least some crystallinity, with grains/crystals having sizes in the nanometer and/or micrometer ranges. Alternatively, the alloy can be substantially amorphous, such as fully amorphous. In one embodiment, the alloy composition is at least substantially not amorphous, such as being substantially crystalline, such as being entirely crystalline.

In one embodiment, the presence of a crystal or a plurality of crystals in an otherwise amorphous alloy can be construed as a “crystalline phase” therein. The degree of crystallinity (or “crystallinity” for short in some embodiments) of an alloy can refer to the amount of the crystalline phase present in the alloy. The degree can refer to, for example, a fraction of crystals present in the alloy. The fraction can refer to volume fraction or weight fraction, depending on the context. A measure of how “amorphous” an amorphous alloy is can be amorphicity. Amorphicity can be measured in terms of a degree of crystallinity. For example, in one embodiment, an alloy having a low degree of crystallinity can be said to have a high degree of amorphicity. In one embodiment, for example, an alloy having 60 vol % crystalline phase can have a 40 vol % amorphous phase.

### Amorphous Alloy or Amorphous Metal

An “amorphous alloy” is an alloy having an amorphous content of more than 50% by volume, preferably more than 90% by volume of amorphous content, more preferably more than 95% by volume of amorphous content, and most preferably more than 99% to almost 100% by volume of amorphous content. Note that, as described above, an alloy high in amorphicity is equivalently low in degree of crystallinity. An “amorphous metal” is an amorphous metal material with a disordered atomic-scale structure. In contrast to most metals, which are crystalline and therefore have a highly ordered arrangement of atoms, amorphous alloys are non-crystalline. Materials in which such a disordered structure is produced directly from the liquid state during cooling are sometimes referred to as “glasses.” Accordingly, amorphous metals are commonly referred to as “metallic glasses” or “glassy metals.” In one embodiment, a bulk metallic glass (“BMG”) can refer to an alloy, of which the microstructure is at least partially amorphous. However, there are several ways besides extremely rapid cooling to produce amorphous metals, including physical vapor deposition, solid-state reaction, ion irradiation, melt spinning, and mechanical alloying. Amorphous alloys can be a single class of materials, regardless of how they are prepared.

Amorphous metals can be produced through a variety of quick-cooling methods. For instance, amorphous metals can be produced by sputtering molten metal onto a spinning metal disk. The rapid cooling, on the order of millions of degrees a second, can be too fast for crystals to form, and the material is thus “locked in” a glassy state. Also, amorphous metals/alloys can be produced with critical cooling rates low enough to allow formation of amorphous structures in thick layers—e.g., bulk metallic glasses.

The terms “bulk metallic glass” (“BMG”), bulk amorphous alloy (“BAA”), and bulk solidifying amorphous alloy are used interchangeably herein. They refer to amorphous alloys having the smallest dimension at least in the millimeter range. For example, the dimension can be at least about 0.5 mm, such as at least about 1 mm, such as at least about 2 mm, such as at least about 4 mm, such as at least about 5 mm, such as at least about 6 mm, such as at least about 8 mm, such as at least about 10 mm, such as at least about 12 mm. Depending on the geometry, the dimension can refer to the diameter, radius, thickness, width, length, etc. A BMG can also be a metallic glass having at least one dimension in the centimeter range, such as at least about 1.0 cm, such as at least about 2.0 cm, such as at least about 5.0 cm, such as at least about 10.0 cm. In some embodiments, a BMG can have at least one dimension at least in the meter range. A BMG can take any of the shapes or forms described above, as related to a metallic glass. Accordingly, a BMG described herein in some embodiments can be different from a thin film made by a conventional deposition technique in one important aspect—the former can be of a much larger dimension than the latter.

Amorphous metals can be an alloy rather than a pure metal. The alloys may contain atoms of significantly different sizes, leading to low free volume (and therefore having viscosity up to orders of magnitude higher than other metals and alloys) in a molten state. The viscosity prevents the atoms from moving enough to form an ordered lattice. The material structure may result in low shrinkage during cooling and resistance to plastic deformation. The absence of grain boundaries, the weak spots of crystalline materials in some cases, may, for example, lead to better resistance to wear and corrosion. In one embodiment, amorphous metals, while technically glasses, may also be much tougher and less brittle than oxide glasses and ceramics.

Thermal conductivity of amorphous materials may be lower than that of their crystalline counterparts. To achieve formation of an amorphous structure even during slower cooling, the alloy may be made of three or more components, leading to complex crystal units with higher potential energy and lower probability of formation. The formation of amorphous alloy can depend on several factors: the composition of the components of the alloy; the atomic radius of the components (preferably with a significant difference of over 12% to achieve high packing density and low free volume); and the negative heat of mixing the combination of components, inhibiting crystal nucleation and prolonging the time the molten metal stays in a supercooled state. However, as the formation of an amorphous alloy is based on many different variables, it can be difficult to make a prior determination of whether an alloy composition would form an amorphous alloy.

Amorphous alloys, for example, of boron, silicon, phosphorus, and other glass formers with magnetic metals (iron, cobalt, nickel) may be magnetic, with low coercivity and high electrical resistance. The high resistance leads to low losses by eddy currents when subjected to alternating magnetic fields, a property useful, for example, as transformer magnetic cores.

Amorphous alloys may have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which can have none of the defects (such as dislocations) that limit the strength of crystalline alloys. For example, one modern amorphous metal, known as Vitreloy™, has a tensile strength that is almost twice that of high-grade titanium. In some embodiments, metallic glasses at room temperature are not ductile and tend to fail suddenly when loaded in tension, which limits the material applicability in reliability-critical applications, as the impending failure is not evident. Therefore, to overcome this challenge, metal matrix composite materials having a metallic glass matrix containing dendritic particles or fibers of a ductile crystalline metal can be used. Alternatively, a BMG low in element(s) that tend to cause embitterment (e.g., Ni) can be used. For example, a Ni-free BMG can be used to improve the ductility of the BMG.

Another useful property of bulk amorphous alloys is that they can be true glasses; in other words, they can soften and flow upon heating. This can allow for easy processing, such as by injection molding, in much the same way as polymers. As a result, amorphous alloys can be used for making sports equipment, medical devices, electronic components and equipment, and thin films. Thin films of amorphous metals can be deposited as protective coatings via a high velocity oxygen fuel technique.

A material can have an amorphous phase, a crystalline phase, or both. The amorphous and crystalline phases can have the same chemical composition and differ only in the microstructure—i.e., one amorphous and the other crystalline. Microstructure in one embodiment refers to the structure of a material as revealed by a microscope at 25×magnification or higher. Alternatively, the two phases can have different chemical compositions and microstructures. For example, a composition can be partially amorphous, substantially amorphous, or completely amorphous.

As described above, the degree of amorphicity (and conversely the degree of crystallinity) can be measured by fraction of crystals present in the alloy. The degree can refer to volume fraction of weight fraction of the crystalline phase present in the alloy. A partially amorphous composition can refer to a composition of at least about 5 vol % of which is of an amorphous phase, such as at least about 10 vol %, such as at least about 20 vol %, such as at least about 40 vol %, such as at least about 60 vol %, such as at least about 80 vol %, such as at least about 90 vol %. The terms “substantially” and “about” have been defined elsewhere in this application. Accordingly, a composition that is at least substantially amorphous can refer to one of which at least about 90 vol % is amorphous, such as at least about 95 vol %, such as at least about 98 vol %, such as at least about 99 vol %, such as at least about 99.5 vol %, such as at least about 99.8 vol %, such as at least about 99.9 vol %. In one embodiment, a substantially amorphous composition can have some incidental, insignificant amount of crystalline phase present therein.

In one embodiment, an amorphous alloy composition can be homogeneous with respect to the amorphous phase. A substance that is uniform in composition is homogeneous. This is in contrast to a substance that is heterogeneous. The term “composition” refers to the chemical composition and/or microstructure in the substance. A substance is homogeneous when a volume of the substance is divided in half and both halves have substantially the same composition. For example, a particulate suspension is homogeneous when a volume of the particulate suspension is divided in half and both halves have substantially the same volume of particles. However, it might be possible to see the individual particles under a microscope. Another example of a homogeneous substance is air where different ingredients therein are equally suspended, though the particles, gases and liquids in air can be analyzed separately or separated from air.

A composition that is homogeneous with respect to an amorphous alloy can refer to one having an amorphous phase substantially uniformly distributed throughout its microstructure. In other words, the composition macroscopically comprises a substantially uniformly distributed amorphous alloy throughout the composition. In an alternative embodiment, the composition can be of a composite, having an amorphous phase having therein a non-amorphous phase. The non-amorphous phase can be a crystal or a plurality of crystals. The crystals can be in the form of particulates of any shape, such as spherical, ellipsoid, wire-like, rod-like, sheet-like, flake-like, or an irregular shape. In one embodiment, it can have a dendritic form. For example, an at least partially amorphous composite composition can have a crystalline phase in the shape of dendrites dispersed in an amorphous phase matrix; the dispersion can be uniform or non-uniform, and the amorphous phase and the crystalline phase can have the same or a different chemical composition. In one embodiment, they have substantially the same chemical composition. In another embodiment, the crystalline phase can be more ductile than the BMG phase.

The methods described herein can be applicable to any type of amorphous alloy. Similarly, the amorphous alloy described herein as a constituent of a composition or article can be of any type. The amorphous alloy can comprise the element Zr, Hf, Ti, Cu, Ni, Pt, Pd, Fe, Mg, Au, La, Ag, Al, Mo, Nb, Be, or combinations thereof. Namely, the alloy can include any combination of these elements in its chemical formula or chemical composition. The elements can be present at different weight or volume percentages. For example, an iron “based” alloy can refer to an alloy having a non-insignificant weight percentage of iron present therein, the weight percent can be, for example, at least about 20 wt %, such as at least about 40 wt %, such as at least about 50 wt %, such as at least about 60 wt %, such as at least about 80 wt %. Alternatively, in one embodiment, the above-described percentages can be volume percentages, instead of weight percentages. Accordingly, an amorphous alloy can be zirconium-based, titanium-based, platinum-based, palladium-based, gold-based, silver-based, copper-based, iron-based, nickel-based, aluminum-based, molybdenum-based, and the like. The alloy can also be free of any of the aforementioned elements to suit a particular purpose. For example, in some embodiments, the alloy, or the composition including the alloy, can be substantially free of nickel, aluminum, titanium, beryllium, or combinations thereof. In one embodiment, the alloy or the composite is completely free of nickel, aluminum, titanium, beryllium, or combinations thereof.

For example, the amorphous alloy can have the formula (Zr, Ti)ₐ(Ni, Cu, Fe)_{b}(Be, Al, Si, B)_{c}, wherein a, b, and c each represents a weight or atomic percentage. In one embodiment, a is in the range of from 30 to 75, b is in the range of from 5 to 60, and c is in the range of from 0 to 50 in atomic percentages. Alternatively, the amorphous alloy can have the formula (Zr, Ti)ₐ(Ni, Cu)_{b}(Be)_{c}, wherein a, b, and c each represents a weight or atomic percentage. In one embodiment, a is in the range of from 40 to 75, b is in the range of from 5 to 50, and c is in the range of from 5 to 50 in atomic percentages. The alloy can also have the formula (Zr, Ti)ₐ(Ni, Cu)_{b}(Be)_{c}, wherein a, b, and c each represents a weight or atomic percentage. In one embodiment, a is in the range of from 45 to 65, b is in the range of from 7.5 to 35, and c is in the range of from 10 to 37.5 in atomic percentages. Alternatively, the alloy can have the formula (Zr)ₐ(Nb, Ti)_{b}(Ni, Cu)_{c}(Al)_{d}, wherein a, b, c, and d each represents a weight or atomic percentage. In one embodiment, a is in the range of from 45 to 65, b is in the range of from 0 to 10, c is in the range of from 20 to 40 and d is in the range of from 7.5 to 15 in atomic percentages. One exemplary embodiment of the aforedescribed alloy system is a Zr—Ti—Ni—Cu—Be based amorphous alloy under the trade name Vitreloy™, such as Vitreloy-1 and Vitreloy-101, as fabricated by Liquidmetal Technologies, CA, USA. Some examples of amorphous alloys of the different systems are provided in Table 1 and Table 2.

TABLE 1
Exemplary amorphous alloy compositions

| Alloy | Atm % | Atm % | Atm % | Atm % | Atm % | Atm % | Atm % | Atm % |
|---|---|---|---|---|---|---|---|---|
| 1 | Fe | Mo | Ni | Cr | P | C | B | |
| | 68.00% | 5.00% | 5.00% | 2.00% | 12.50% | 5.00% | 2.50% | |
| 2 | Fe | Mo | Ni | Cr | P | C | B | Si |
| | 68.00% | 5.00% | 5.00% | 2.00% | 11.00% | 5.00% | 2.50% | 1.50% |
| 3 | Pd | Cu | Co | P | | | | |
| | 44.48% | 32.35% | 4.05% | 19.11% | | | | |
| 4 | Pd | Ag | Si | P | | | | |
| | 77.50% | 6.00% | 9.00% | 7.50% | | | | |
| 5 | Pd | Ag | Si | P | Ge | | | |
| | 79.00% | 3.50% | 9.50% | 6.00% | 2.00% | | | |
| 6 | Pt | Cu | Ag | P | B | Si | | |
| | 74.70% | 1.50% | 0.30% | 18.0% | 4.00% | 1.50% | | |

TABLE 2
Additional Exemplary amorphous alloy compositions (atomic %)

| Alloy | Atm % | Atm % | Atm % | Atm % | Atm % | Atm % |
|---|---|---|---|---|---|---|
| 1 | Zr | Ti | Cu | Ni | Be | |
| | 41.20% | 13.80% | 12.50% | 10.00% | 22.50% | |
| 2 | Zr | Ti | Cu | Ni | Be | |
| | 44.00% | 11.00% | 10.00% | 10.00% | 25.00% | |
| 3 | Zr | Ti | Cu | Ni | Nb | Be |
| | 56.25% | 11.25% | 6.88% | 5.63% | 7.50% | 12.50% |
| 4 | Zr | Ti | Cu | Ni | Al | Be |
| | 64.75% | 5.60% | 14.90% | 11.15% | 2.60% | 1.00% |
| 5 | Zr | Ti | Cu | Ni | Al | |
| | 52.50% | 5.00% | 17.90% | 14.60% | 10.00% | |
| 6 | Zr | Nb | Cu | Ni | Al | |
| | 57.00% | 5.00% | 15.40% | 12.60% | 10.00% | |
| 7 | Zr | Cu | Ni | Al | | |
| | 50.75% | 36.23% | 4.03% | 9.00% | | |
| 8 | Zr | Ti | Cu | Ni | Be | |
| | 46.75% | 8.25% | 7.50% | 10.00% | 27.50% | |
| 9 | Zr | Ti | Ni | Be | | |
| | 21.67% | 43.33% | 7.50% | 27.50% | | |
| 10 | Zr | Ti | Cu | Be | | |
| | 35.00% | 30.00% | 7.50% | 27.50% | | |
| 11 | Zr | Ti | Co | Be | | |
| | 35.00% | 30.00% | 6.00% | 29.00% | | |
| 12 | Zr | Ti | Fe | Be | | |
| | 35.00% | 30.00% | 2.00% | 33.00% | | |
| 13 | Au | Ag | Pd | Cu | Si | |
| | 49.00% | 5.50% | 2.30% | 26.90% | 16.30% | |
| 14 | Au | Ag | Pd | Cu | Si | |
| | 50.90% | 3.00% | 2.30% | 27.80% | 16.00% | |
| 15 | Pt | Cu | Ni | P | | |
| | 57.50% | 14.70% | 5.30% | 22.50% | | |
| 16 | Zr | Ti | Nb | Cu | Be | |
| | 36.60% | 31.40% | 7.00% | 5.90% | 19.10% | |
| 17 | Zr | Ti | Nb | Cu | Be | |
| | 38.30% | 32.90% | 7.30% | 6.20% | 15.30% | |
| 18 | Zr | Ti | Nb | Cu | Be | |
| | 39.60% | 33.90% | 7.60% | 6.40% | 12.50% | |
| 19 | Cu | Ti | Zr | Ni | | |
| | 47.00% | 34.00% | 11.00% | 8.00% | | |
| 20 | Zr | Co | Al | | | |
| | 55.00% | 25.00% | 20.00% | | | |

Other exemplary ferrous metal-based alloys include compositions such as those disclosed in U.S. Patent Application Publication Nos. 2007/0079907 and 2008/0305387. These compositions include the Fe(Mn, Co, Ni, Cu) (C, Si, B, P, Al) system, wherein the Fe content is from 60 to 75 atomic percentage, the total of (Mn, Co, Ni, Cu) is in the range of from 5 to 25 atomic percentage, and the total of (C, Si, B, P, Al) is in the range of from 8 to 20 atomic percentage, as well as the exemplary composition Fe48Cr15 Mo14Y2C15B6. They also include the alloy systems described by Fe—Cr—Mo—(Y,Ln)—C—B, Co—Cr—Mo-Ln-C—B, Fe—Mn—Cr—Mo—(Y,Ln)—C—B, (Fe,Cr,Co)—(Mo,Mn)—(C,B)—Y, Fe—(Co,Ni)—(Zr,Nb,Ta)—(Mo,W)—B, Fe—(Al,Ga)—(P,C,B,Si,Ge), Fe—(Co,Cr,Mo,Ga,Sb)—P—B—C, (Fe,Co)—B—Si—Nb alloys, and Fe—(Cr—Mo)—(C,B)—Tm, where Ln denotes a lanthanide element and Tm denotes a transition metal element. Furthermore, the amorphous alloy can also be one of the exemplary compositions Fe80P12.5C5B2.5, Fe80P11C5B2.5Si1.5, Fe74.5Mo5.5P12.5C5B2.5, Fe74.5Mo5.5P11C5B2.5Si1.5, Fe70Mo5Ni5P12.5C5B2.5, Fe70Mo5Ni5P11C5B2.5Si1.5, Fe68Mo5Ni5Cr2P12.5C5B2.5, and Fe68Mo5Ni5Cr2P11C5B2.5Si1.5, described in U.S. Patent Application Publication No. 2010/0300148.

The amorphous alloys can also be ferrous alloys, such as (Fe, Ni, Co) based alloys. Examples of such compositions are disclosed in U.S. Pat. Nos. 6,325,868; 5,288,344; 5,368,659; 5,618,359; and 5,735,975, Inoue et al., Appl. Phys. Lett., Volume 71, p 464 (1997), Shen et al., Mater. Trans., JIM, Volume 42, p 2136 (2001), and Japanese Patent Application No. 200126277 (Pub. No. 2001303218 A). One exemplary composition is Fe₇₂Al₅Ga₂P₁₁C₆B₄. Another example is Fe₇₂Al₇Zr₁₀Mo₅W₂B₁₅. Another iron-based alloy system that can be used in the coating herein is disclosed in U.S. Patent Application Publication No. 2010/0084052, wherein the amorphous metal contains, for example, manganese (1 to 3 atomic %), yttrium (0.1 to 10 atomic %), and silicon (0.3 to 3.1 atomic %) in the range of composition given in parentheses; and that contains the following elements in the specified range of composition given in parentheses: chromium (15 to 20 atomic %), molybdenum (2 to 15 atomic %), tungsten (1 to 3 atomic %), boron (5 to 16 atomic %), carbon (3 to 16 atomic %), and the balance iron.

The amorphous alloy can also be one of the Pt- or Pd-based alloys described by U.S. Patent Application Publication Nos. 2008/0135136, 2009/0162629, and 2010/0230012. Exemplary compositions include Pd44.48Cu32.35Cu4.05P19.11, Pd77.5Ag6Si9P7.5, and Pt74.7Cu1.5Ag0.3P18B4Si1.5.

The aforedescribed amorphous alloy systems can further include additional elements, such as additional transition metal elements, including Nb, Cr, V, and Co. The additional elements can be present at less than or equal to about 30 wt %, such as less than or equal to about 20 wt %, such as less than or equal to about 10 wt %, such as less than or equal to about 5 wt %. In one embodiment, the additional, optional element is at least one of cobalt, manganese, zirconium, tantalum, niobium, tungsten, yttrium, titanium, vanadium and hafnium to form carbides and further improve wear and corrosion resistance. Further optional elements may include phosphorous, germanium and arsenic, totaling up to about 2%, and preferably less than 1%, to reduce melting point. Otherwise incidental impurities should be less than about 2% and preferably 0.5%.

In some embodiments, a composition having an amorphous alloy can include a small amount of impurities. The impurity elements can be intentionally added to modify the properties of the composition, such as improving the mechanical properties (e.g., hardness, strength, fracture mechanism, etc.) and/or improving the corrosion resistance. Alternatively, the impurities can be present as inevitable, incidental impurities, such as those obtained as a byproduct of processing and manufacturing. The impurities can be less than or equal to about 10 wt %, such as about 5 wt %, such as about 2 wt %, such as about 1 wt %, such as about 0.5 wt %, such as about 0.1 wt %. In some embodiments, these percentages can be volume percentages instead of weight percentages. In one embodiment, the alloy sample/composition consists essentially of the amorphous alloy (with only a small incidental amount of impurities). In another embodiment, the composition includes the amorphous alloy (with no observable trace of impurities).

In one embodiment, the final parts exceeded the critical casting thickness of the bulk solidifying amorphous alloys.

In embodiments herein, the existence of a supercooled liquid region in which the bulk-solidifying amorphous alloy can exist as a high viscous liquid allows for superplastic forming. Large plastic deformations can be obtained. The ability to undergo large plastic deformation in the supercooled liquid region is used for the forming and/or cutting process. As oppose to solids, the liquid bulk solidifying alloy deforms locally which drastically lowers the required energy for cutting and forming. The ease of cutting and forming depends on the temperature of the alloy, the mold, and the cutting tool. As higher is the temperature, the lower is the viscosity, and consequently easier is the cutting and forming.

Embodiments herein can utilize a thermoplastic-forming process with amorphous alloys carried out between Tg and Tx, for example. Herein, Tx and Tg are determined from standard DSC measurements at typical heating rates (e.g. 20° C./min) as the onset of crystallization temperature and the onset of glass transition temperature.

The amorphous alloy components can have the critical casting thickness and the final part can have thickness that is thicker than the critical casting thickness. Moreover, the time and temperature of the heating and shaping operation is selected such that the elastic strain limit of the amorphous alloy could be substantially preserved to be not less than 1.0%, and preferably not being less than 1.5%. In the context of the embodiments herein, temperatures around glass transition means the forming temperatures can be below glass transition, at or around glass transition, and above glass transition temperature, but preferably at temperatures below the crystallization temperature Tₓ. The cooling step is carried out at rates similar to the heating rates at the heating step, and preferably at rates greater than the heating rates at the heating step. The cooling step is also achieved preferably while the forming and shaping loads are still maintained.

### Electronic Devices

The embodiments herein can be valuable in the fabrication of electronic devices using a BMG. An electronic device herein can refer to any electronic device known in the art. For example, it can be a telephone, such as a cell phone, and a land-line phone, or any communication device, such as a smart phone, including, for example an iPhone™, and an electronic email sending/receiving device. It can be a part of a display, such as a digital display, a TV monitor, an electronic-book reader, a portable web-browser (e.g., iPad™), and a computer monitor. It can also be an entertainment device, including a portable DVD player, conventional DVD player, Blue-Ray disk player, video game console, music player, such as a portable music player (e.g., iPod™), etc. It can also be a part of a device that provides control, such as controlling the streaming of images, videos, sounds (e.g., Apple TV™), or it can be a remote control for an electronic device. It can be a part of a computer or its accessories, such as the hard drive tower housing or casing, laptop housing, laptop keyboard, laptop track pad, desktop keyboard, mouse, and speaker. The article can also be applied to a device such as a watch or a clock.

A proposed solution according to embodiments herein for melting meltable materials (e.g., metals or metal alloys), in a vessel is to control the temperature at an interface or contact point between the meltable material and the vessel by an active cooling regulation.

An embodiment relates to a method comprising heating a meltable material to form a melt in a vessel, wherein the vessel comprises at least one cooling channel; comparing a contact temperature T_{Contact} of the vessel in contact with the melt with a skull temperature T_{Skull} and a wetting temperature T_{Wetting} of the melt in the vessel; and regulating a cooling rate in the at least one cooling channel such that Tₛₖᵤₗₗ<T_{Contact}<_{Wetting} and the meltable material does not wet a surface of the vessel. The method could further comprise measuring the contact temperature T_{Contact}, wherein the measuring T_{Contact} comprises directly measuring the vessel at an interface with the melt. The method could further comprise obtaining a look-up table relating the temperature of the coolant to T_{Contact}. The method could further comprise increasing the cooling rate to decrease T_{Contact}. The method could further comprise decreasing the cooling rate to increase T_{Contact}. The method could further comprise increasing the cooling rate to cool the melt before transporting the melt into an atmosphere or a reactive environment.

Optionally, the measuring T_{Contact} comprises measuring a temperature of a coolant in the at least one cooling channel to determine T_{Contact}. Optionally, the regulating the cooling rate comprises selecting a coolant, a flow rate, a flow time, or a combination thereof in the at least one cooling channel. Optionally, the regulating the cooling rate comprises monitoring T_{Contact}, when heating, to slow down the cooling rate to inch up T_{Contact} to close to T_{Wetting}. Optionally, the regulating the cooling rate comprises an on and off control of a coolant in the at least one channel. Optionally, when the cooling is controlled on, the coolant has a substantially steady state flow rate. Optionally, when the cooling is controlled off, the coolant has a zero flow rate or is removed from the at least one cooling channel.

Another embodiment relates to a method comprising heating a meltable material to form a melt in a vessel, wherein the vessel comprises at least one cooling channel; comparing a contact temperature T_{Contact} of an the vessel at an interface with the melt and a wetting threshold temperature T_{Th-I}, wherein T_{Th-I}=T_{Wetting}−T_{sm-I}, and T_{sm-I} is a temperature safety margin for T_{Wetting}; and regulating a cooling rate in the at least one cooling channel such that T_{Contact} is a value close or equal to T_{Th-I}. The method could further comprise measuring the T_{Contact}, wherein the measuring T_{Contact} comprises directly measuring the vessel at the interface with the melt. The method could further comprise obtaining a look-up table relating the temperature of the coolant to T_{Contact}. The method could further comprise increasing the cooling rate to cool the melt before transporting the melt into an atmosphere or a reactive environment.

Optionally, the regulating the cooling rate comprises increasing the cooling rate to decrease T_{Contact} if the measured T_{Contact}>T_{Th-I}. Optionally, the regulating the cooling rate comprises decreasing the cooling rate to increase T_{Contact} if the measured T_{Contact}<T_{Th-I}. Optionally, the measuring T_{Contact} comprises measuring a temperature of a coolant in the at least one cooling channel to determine T_{Contact}. Optionally, the regulating the cooling rate comprises selecting a coolant, a flow rate, a flow time, or a combination thereof in the at least one cooling channel. Optionally, the regulating the cooling rate comprises monitoring T_{Contact}, when heating, to slow down the cooling rate to inch up T_{Contact} to close to T_{Th-I}. Optionally, the regulating the cooling rate comprises an on and off control of a coolant in the at least one channel. Optionally, when the cooling is controlled on, the coolant has a substantially steady state flow rate. Optionally, when the cooling is controlled off, the coolant has a zero flow rate or is removed from the at least one cooling channel.

Another embodiment relates to a method comprising heating a meltable material to form a melt in a vessel, wherein the vessel comprises at least one cooling channel; comparing a contact temperature T_{Contact} of the vessel at an interface with the melt and one or both of a wetting threshold temperature T_{Th-I} and a skull forming threshold temperature T_{Th-II}, wherein T_{Th-I}=T_{Wetting}−T_{sm-I}, and T_{sm-I} is a temperature safety margin for T_{Wetting}, and wherein T_{Th-II}=T_{Skull}+T_{sm-II}, T_{sm-II} is a temperature safety margin for T_{Skull}; and regulating a cooling rate in the at least one cooling channel such that T_{Th-II}≦T_{Contact}≦T_{Th-I}. The method could further comprise measuring the T_{Contact}, wherein the measuring T_{Contact} comprises directly measuring the vessel at the interface with the melt.

Optionally, the regulating the cooling rate comprises increasing the cooling rate to decrease T_{Contact} if the measured T_{Contact}>T_{Th-I}. Optionally, the regulating the cooling rate comprises decreasing the cooling rate to increase T_{Contact} if the measured T_{Contact}<T_{Th-II}. Optionally, the measuring T_{Contact} comprises measuring a temperature of a coolant in the at least one cooling channel to determine T_{Contact}. Optionally, the regulating the cooling rate comprises selecting a coolant, a flow rate, a flow time, or a combination thereof in the at least one cooling channel. Optionally, the regulating the cooling rate comprises an on and off control of a coolant in the at least one channel.

Another embodiment relates to a melting system comprising a heating component configured to heat a meltable material in a vessel; a cooling component comprising a cooling controller and a cooling channel, wherein the cooling channel is configured to flow a coolant therein; and a thermal sensor configured to measure a contact temperature T_{Contact} at an interface between the heated meltable material and the vessel, wherein the cooling controller is configured to regulate a cooling rate of the coolant by comparing the T_{Contact} with at least one temperature of the melt.

Optionally, the at least one temperature of the melt comprises a wetting temperature T_{wetting} of the melt, a skull forming temperature Tₛₖᵤₗₗ, a wetting threshold temperature T_{Th-I}, a skull forming threshold temperature T_{Th-II}, or combinations thereof. Optionally, the cooling controller is configured to control a flow rate and a flow time of the coolant, a temperature of the coolant, an on and off control of the flow, and combinations thereof. Optionally, the thermal sensor is configured to measure a temperature of the coolant. Optionally, the thermal sensor is configured within the vessel to directly measure the contact temperature T_{Contact}.

Another embodiment relates to an apparatus comprising a computer connected to a melting system, the melting system comprising: a heating component configured to heat a meltable material in a vessel, a cooling component comprising a cooling controller and a cooling channel, wherein the cooling channel is configured to flow a coolant therein, and a thermal sensor configured to measure a contact temperature T_{Contact} at an interface between the heated meltable material and the vessel, wherein the computer is configured to compare T_{Contact} with one or more of a skull forming temperature T_{Skull}, a wetting temperature T_{Wetting}, a wetting threshold temperature T_{Th-I}, and a skull forming threshold temperature T_{Th-II} for regulating a cooling rate in the cooling channel.

Optionally, the cooling controller is configured to control the cooling rate. Optionally, the cooling controller is configured to control a flow rate and a flow time of the coolant, a temperature of the coolant, an on and off control of the flow, and combinations thereof. Optionally, the thermal sensor is configured to measure a temperature of the coolant. Optionally, the thermal sensor is configured within the vessel to directly measure the contact temperature T_{Contact}.

In accordance with various embodiments, there is provided a method of active cooling regulation of a melting process. A meltable material can be melted in a vessel that includes at least one cooling channel configured therein. A contact temperature T_{Contact} of the vessel at in contact with the melt can be measured and compared with a skull forming temperature T_{Skull} and a wetting temperature T_{Wetting} of the melt to wet the vessel. A cooling rate in the cooling channel(s) can then be regulated such that T_{Skull}<T_{Contact}<T_{Wetting}.

In accordance with various embodiments, there is provided a method of active cooling regulation of a melting process. A meltable material can be melted in a vessel that includes at least one cooling channel configured therein. The contact temperature T_{Contact} of the vessel at in contact with the melt can be measured and compared with a wetting threshold temperature T_{Th-I}, wherein T_{Th-I}=T_{Wetting}−T_{sm-I}, and T_{sm-I} is a temperature safety margin for T_{Wetting}. A cooling rate in the at least one cooling channel can then be regulated such that T_{Contact} is a value close to T_{Th-I}.

In accordance with various embodiments, there is provided a method of active cooling regulation of a melting process. A meltable material can be melted in a vessel that includes at least one cooling channel configured therein. A contact temperature T_{Contact} of the vessel at an interface with the melt can be measured and compared with one or both of a wetting threshold temperature T_{Th-I} and a skull forming threshold temperature T_{Th-II}, wherein T_{Th-I}=T_{Wetting}−T_{sm-I}, and T_{sm-I} is a temperature safety margin for T_{Wetting}, and T_{Th-II}=T_{Skull}+T_{sm-II}, T_{sm-II} is a temperature safety margin for T_{Skull}. A cooling rate can then be regulated in the at least one cooling channel such that T_{Th-II}≦T_{Contact}≦T_{Th-I}.

In accordance with various embodiments, there is provided a melting system with active cooling regulation. The melting system can include a heating component configured to heat a meltable material in a vessel; a cooling component configured to include a cooling controller and a cooling channel; and a thermal sensor configured to measure a contact temperature T_{Contact} at an interface between the heated meltable material and the vessel. The cooling channel can be configured to flow a coolant therein.

The thermal sensor could be surface mounted resistance temperature detector (RTD). The RTD sensors measure temperature by correlating the resistance of the RTD element with temperature. Most RTD elements include a length of fine coiled wire wrapped around a ceramic or glass core. The element is usually quite fragile, so it is often placed inside a sheathed probe to protect it. The RTD element is made from a pure material, platinum, nickel or copper. The material has a predictable change in resistance as the temperature changes; it is this predictable change that is used to determine temperature. Surface mounted sensors are used when immersion into a process fluid is not possible due to configuration of the apparatus, or the fluid properties may not allow an immersion style sensor. Configurations of surface mounted sensors range from tiny cylinders to large blocks which are mounted by clamps, adhesives, or bolted into place. Most require the addition of insulation to isolate them from cooling or heating effects of the ambient conditions to insure accuracy. Surface mounted sensors can measure the contact temperature of a liquid such as a melt in a vessel as a close approximation of the actual temperature of the melt at the contacting surface.

In accordance with various embodiments, there is provided an apparatus of active cooling regulation of a melting process. The apparatus can include a computer and a melting system. The melting system can include a heating component configured to heat a meltable material in a vessel, a cooling component including a cooling controller and configured to flow a coolant therein, and a thermal sensor configured to measure contact temperature T_{Contact} between the heated meltable material and the vessel. The computer compares T_{Contact} with one or more of a skull forming temperature of T_{Skull}, a wetting temperature T_{Wetting}, a wetting threshold temperature T_{Th-I}, and a skull forming threshold temperature T_{Th-II} for regulating a cooling rate in the cooling component.

In accordance with various embodiments, a coolant flow rate can be regulated to regulate the temperature such as T_{Contact} in an inline melting system or other types of melting systems. If a coolant such as a cooling water is actively controlled, the melt overheat can be increased during the melting cycle by reducing the cooling rate of a vessel (e.g., boat, crucible, container, etc.) that contains the melt. Alternatively, the cooling can be turned off for a short duration during the melting cycle to maximize overheat of the melt. After the melt is processed, the cooling can be increased to prevent surfaces which may still contain hot alloy from reacting excessively with atmospheric contaminants in the chamber containing the vessel.

In embodiments, the vessel may include one or more cooling channel(s) configured therein to flow a fluid such as a coolant for actively regulating the cooling process of the coolant and thus regulating the melting temperature. The melt or the molten material in the vessel may be cast into articles as desired by a casting process, for example. In one embodiment, the cast article may include BMG articles, although non-BMG articles may also be encompassed in the present disclosure.

The vessel may include a melting portion configured to receive meltable material to be melted therein. The melting portion provides an interface or a contact point between the vessel and the meltable materials (or the melt). The cooling channels may be embedded in the vessel and associated with the melting portion of the vessel to cool the vessel and the material placed on the melting portion of the vessel. The cooling process may be conducted by circulating coolant in the cooling channel(s) during the melting process of the meltable materials.

During conventional cooling process, a skull layer may be formed due to contact and solidification of the melt on the cooled surface of the vessel. The skull layer may be a layer of crystalline of the meltable material. As used herein, the temperature at which a skull layer is formed can be referenced herein as a skull forming temperature T_{Skull}.

As used herein, the term “wetting” refers to spreading of a liquid, for example, a liquid such as a melt, on a solid surface. The solid surface may be, e.g., surface of a vessel. The wetting may be characterized by wetting temperature T_{Wetting} and/or wetting angle. Wetting could be characterized by the contact angle between the liquid and the solid surface. A contact angle less than 90° (low contact angle) usually indicates wetting of the surface is favorable, and the fluid will “wet” and spread over a large area of the surface such that there is “wetting.” Contact angles greater than 90° (high contact angle) means that wetting of the surface is unfavorable so the fluid will minimize contact with the surface such that there is “no wetting” and form a compact liquid droplet. A liquid can be “wetting” on one solid surface and “not wetting” on another solid surface.

As used herein, the term “wetting temperature” or “T_{Wetting}” refers to a temperature at which a meltable material (e.g., an alloy charge) becomes a fluid (e.g., a molten material) and the fluid spreads on a solid surface (e.g., the vessel) to wet the solid surface. At the wetting temperature T_{wetting}, the melt may be able to interact with the solid surface of the vessel. The interaction there-between may include a reaction (chemical or physical) between the elements of the melt and those of the vessel. In some cases, the interaction between the melt and the vessel may include fusion of the two materials at the contact point. Such interaction is also sometimes referred to as “attack” on the wall of vessel, or, alternatively, “contamination” of the melt such as an alloy charge. The reaction may refer to various types of reactions. For example, it can refer to dissolution of the elements of the vessel into the molten alloy, causing contamination of the molten alloy by the constituent elements of the vessel. Dissolution can involve the breakdown of the crystals that make up the vessel and the diffusion of those elements into the molten alloy. It can also refer to diffusion of the molten alloy into the vessel.

The wetting temperature T_{Wetting} may be increased or decreased depending on the wetting conditions at the interface between the melt and the solid surface of a vessel. The wetting conditions may be determined by, e.g., compositions of the meltable material and the underlying solid surface, surface properties of the solid surface, interactions between the melt and the underlying solid surface, pressure or vacuum, etc. However, for a pre-defined melting system, the wetting conditions may be pre-defined and the wetting temperature may be pre-defined. In embodiments, the wetting temperature T_{Wetting} may be no greater than the melting temperature T_{Melting} of the meltable material.

As used herein, the term “active cooling regulation” refers to regulation of a cooling process and thus a regulation of melting and/or casting processes. For example, cooling rate of the coolant and/or the cooling effect on the melting process can be regulated such that temperature of the melt, e.g., temperature at the contact between the melt and vessel, T_{Contact}, is regulated or controlled as desired. The cooling can be regulated by selecting suitable coolants and their flow rate, flow time, flow manner, etc. For example, to lower the T_{Contact}, cooling rate or cooling effect can be increased by increasing the flow rate of the coolant. The coolants can be selected to be a gas or a liquid such as water, oil, and/or other suitable solutions.

Exemplary vessels may be a container in a form of, for example, a chamber, a boat, a cup, a crucible, etc. The vessels may have a desirable geometry with any shape or size. For example, it may be cylindrical, spherical, cubic, rectangular, and/or an irregular shape.

The vessels may be formed of for example, a metal such as copper, a metal alloy such as a copper-based metal alloy, a ceramic, a graphite, etc. Exemplary ceramic may include at least one element selected from Groups IVA, VA, and VIA in the Periodic Table. In embodiments, the vessel may be formed of a refractory material. A refractory material may include refractory metals, such as molybdenum, tungsten, tantalum, niobium, rehenium, etc. Alternatively, the refractory material may include a refractory ceramic.

Meltable materials, e.g., metals and/or alloys, may be melted in a vessel, e.g., in a non-reactive environment, to prevent any reaction, contamination, or other conditions which might detrimentally affect the quality of the resulting articles. The metals or alloys may be melted in a vacuum environment or in an inert environment, e.g., argon. In embodiments, single charges or multiple charges of meltable materials at once may be melted in the vessel.

In embodiments, a vessel may be used in a vacuum to inductively melt metals and/or alloys, e.g., using induction melting, electron beam melting, resistance melting, plasma arc, etc. The vessel may be connected to any suitable heat source for melting meltable materials. For example, the heat source may be an inductive heating coil surrounding at least a portion of the vessel. The inductive heating coil may be coupled to a power source to generate a field that passes through the vessel, and heats and melts meltable materials located within the vessel. In some cases, the field also serves, e.g., to agitate or stir the melt. In embodiments, the heating may be carried out under a partial vacuum, such as low vacuum, or even high vacuum, to avoid reaction of the alloy with air.

The vessel may further include one or more cooling channels to regulate temperature of the melt, e.g., T_{Contact}. The cooling channels provide passages for circulating the coolant from and to a fluid source to pull out or extract heat from the vessel, to prevent melting of the vessel and to control the temperature of the melt. In embodiments, a plurality of cooling channels may be retained in position next to one another within the vessel. The cooling channels may be embedded within the vessel walls.

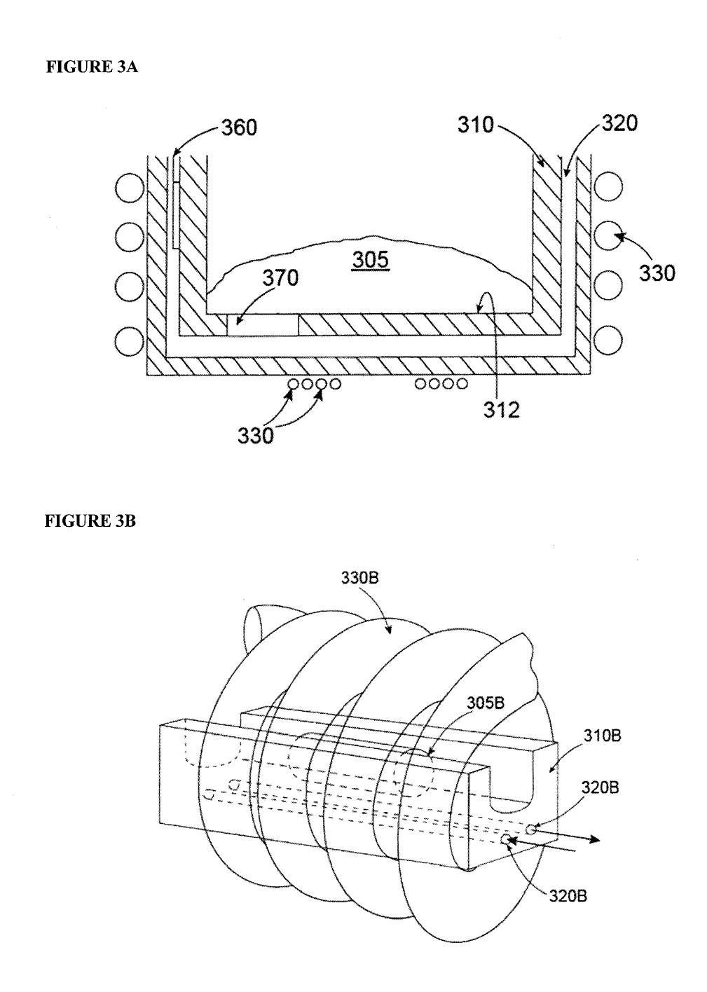

FIG. 3a depicts an exemplary melting system in accordance with various embodiments of the present teachings. Note that FIG. 3a is merely a schematic, and alternative versions of the design can exist.

In FIG. 3a, the melting system may include a vessel 310 having a melting portion surface 312, and cooling channels 320 configured in the vessel 310. The melting system can also include a heating component such as induction coils 330.

The induction coils 330 may be positioned at least about the melting portion of the vessel 310, which can be heated using a power source (not shown). Induction coils 330 may serve as a heat source to melt the meltable material 305, e.g., metal or alloy charge(s), placed on the melting portion surface 312 of the vessel 310 and maintain a molten state as desired. The meltable material 305 may include any possible alloys, for example, Zr-based, Fe-based, Ti-based, Pt-based, Pd-based, gold-based, silver-based, copper-based, Ni-based, Al-based, Mo-based, Co-based alloys, and/or the like, as discussed above. The metal/alloy charge(s) may take any forms, which may include, but are not be limited to, lumps, ingots, granules, plates, powders, and mixtures thereof in the vessel 310. Those skilled in the art will understand that the amount of metal charge(s) placed the vessel may vary depending on intended use. Once meltable materials 305 are placed inside the vessel 310, a cover (not shown in FIG. 3a), which in one embodiment, may be made from the same material as the vessel 310 may be positioned on top and held in place to ensure the vessel 310 is sealed. Power source may be turned on and metal charges may be melted when the appropriate temperature is attained. The electromagnetic field generated by the induction coils 330 may cause the metal charge(s) to heat itself internally due to resistance heating caused by current flow within the metal charge(s). Power levels and frequencies applied to the coils 330 may be selected as desired.

The cooling channels 320 may be positioned, e.g., embedded, at least within the melting portion of the vessel 310. The cooling channels 320 may be configured in a manner that at least a portion of channels 320 is parallel and/or perpendicular to a height of the vessel 310. The vessel 310 may then be water-cooled or gas-cooled by the cooling channels 320 to prevent itself from melting during heating of the meltable material 305. Further, the cooling channels 320 may be configured to regulate temperature of the melt at least while the molten material is heated.

While the vessel may have any shape acceptable for use in induction melting, in some embodiment, the vessel may be generally shaped as a hollow cylinder as shown in FIG. 3a. In other embodiment, the vessel may be, for example, a boat as shown in FIG. 3b.

FIG. 3b depicts a melting system having an exemplary induction heating structure with an induction coil 330b surrounding a hollow section. The induction coil 330b can be configured having a helical pattern. The exemplary vessel 310b can be inserted into the hollow section to be at least partially surrounded by the induction coil 330b. While heating the materials 305b placed in the vessel 310b, the temperature regulating channels 320b can have a fluid passing therein to regulate the contact temperature.

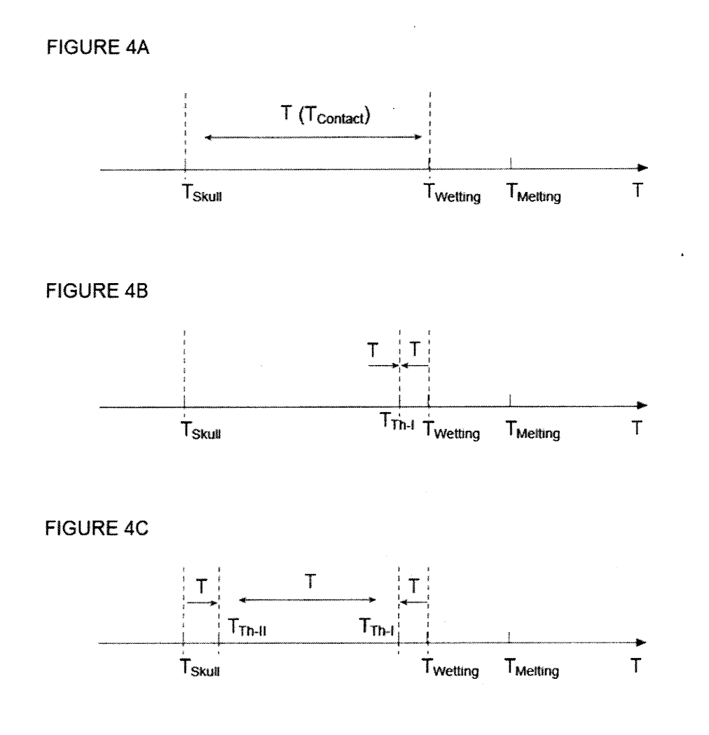

FIGS. 4a-4c are schematics illustrating: a skull forming temperature T_{Skull} at which a skull layer can be formed, a wetting temperature T_{Wetting} at which the melt can wet the vessel surface, and a melting temperature T_{Melting} at which the meltable material can form a molten material. In general, T_{Wetting} is less than the T_{Melting} and greater than T_{Skull} as shown in FIGS. 4a-4c.

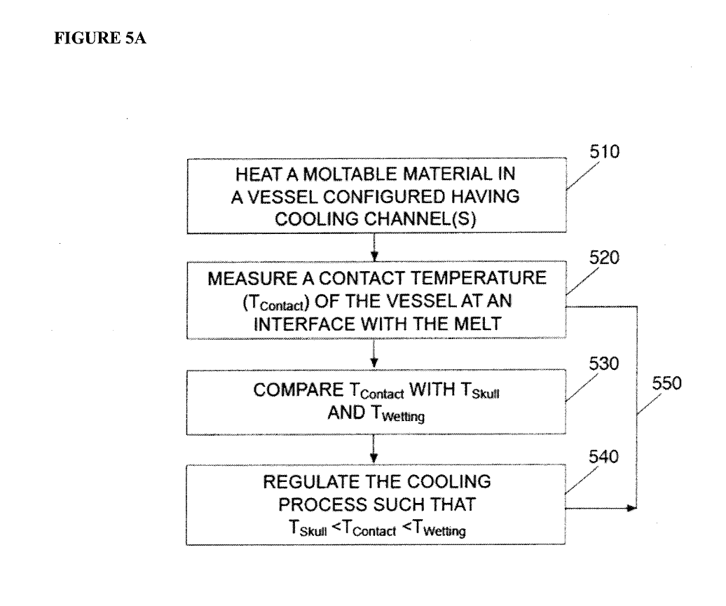

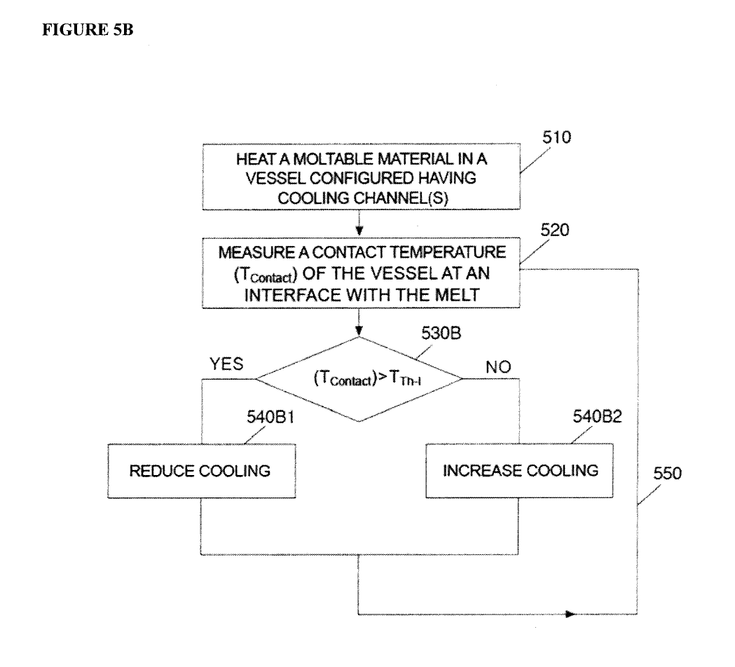

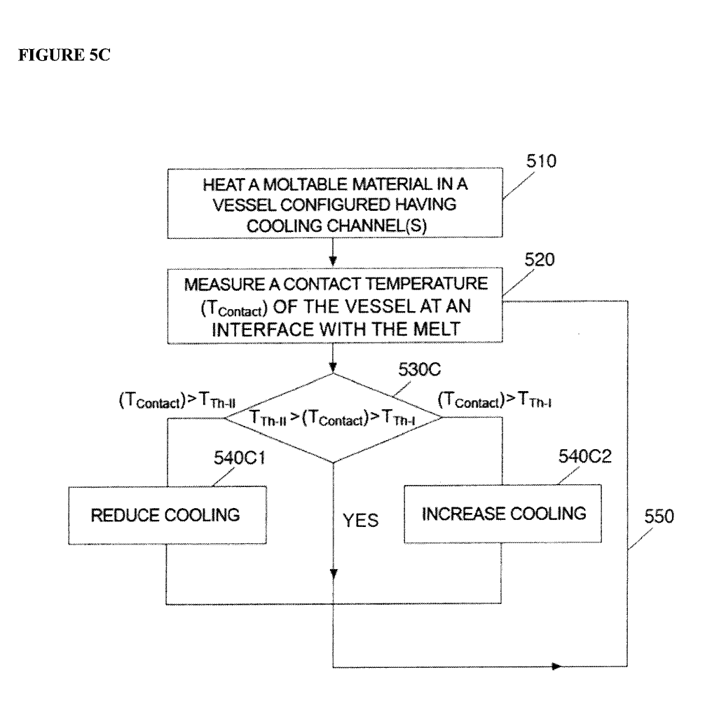

FIGS. 5a-5c depict various methods for actively regulating the contact temperature T_{Contact} between the melt 305 and the vessel 310. Note that FIGS. 3, 4a-4c, and 5a-5c are merely schematics, and alternative versions of the designs can exist. Although FIGS. 3, 4a-4c, and 5a-5c are described in relation with one another, each of the figures is not limited in any manner.

At block 510 of FIG. 5a, a meltable material 305 can be heated and melted in the vessel 310. The vessel 310 may include cooling channel(s) 320 for a coolant to flow or circulate therein.

At block 520 of FIG. 5a, the contact temperature T_{Contact} at the interface between the vessel material and the melt can be monitored and/or measured either directly or indirectly.

In one embodiment, the contact temperature T_{Contact} can be measured indirectly, for example, by placing a thermal couple or thermal sensor 360 (e.g., see FIG. 3a) in the cooling channels 320 to measure a temperature of the coolant therein. Depending on the materials and configurations used in specific melting systems, the coolant temperature may correspond to a temperature of the vessel at the contact point with the melt. In one embodiment, a look up table can be pre-generated, for example, relating the coolant temperature to the temperature of vessel at the contact point with the melt, i.e., T_{Contact}. By measuring the coolant temperature, T_{Contact} can be measured.

In another embodiment, the contact temperature T_{Contact} can be measured directly. For example, a thermal couple or thermal sensor 370 (e.g., see FIG. 3a) can be placed within or adjacent to the melting portion of the vessel 310 such that the contact temperature T_{Contact} can be measured directly from the vessel.

At block 530 in FIG. 5a, the monitored or measured contact temperature T_{Contact} can be compared with the skull forming temperature of the melt T_{Skull} and the wetting temperature T_{Wetting} of the melt to wet the melting surface of the vessel.

At block 540 in FIG. 5a, the contact temperature T_{Contact} can be controlled to be between T_{Skull} and T_{Wetting}. That is, T_{Skull}<T_{Contact}<T_{Wetting}, see FIG. 4a. In this case, no skull layer can be formed between the melt and the vessel material, and no wetting of the melt on the vessel material. The melt may be at least substantially free of the elements diffused from the vessel and may be easily transferred from the vessel surface. In embodiments, for example, referring to FIG. 3a, the contact temperature T_{Contact} of the vessel at the interface 312 of its melting portion with the melt 305 can be actively controlled or regulated such that there is no interaction or fusion of the melt 305 with the vessel materials at the interface 312 and also such that no skull is formed at the bottom of the melt on the interface 312.

The contact temperature T_{Contact} can be controlled, e.g., by controlling cooling (e.g., cooling rate or cooling effect) of the coolant. For example, if the contact temperature T_{Contact} is measured too high, cooling rate/effect of the coolant can be increased so as to reduce T_{Contact}. In the case if the contact temperature T_{Contact} is too low, the cooling rate/effect of the coolant can be decreased to as to increase T_{Contact}. In general, for a selected coolant, the cooling rate/effect can be increased (or decreased) by increasing (decreasing or removing) the flow rate and/or flow time of the coolant in the cooling channel(s) configured in the vessel.

In one embodiment, when T_{Contact} is being increased to a value close to T_{Wetting}, the cooling rate/effect can be reduced slowly, i.e., at a slow rate, such that the contact temperature T_{Contact} can “inch up” close to T_{Wetting} but without exceeding the T_{Wetting}. As a result, the melt or the molten alloy doesn't wet the vessel material and is distinct from the vessel material at a high temperature, allowing more heat into the melt and allowing the melt to reach a maximum temperature value to maximize meting efficiency. In other words, the coolant or the cooling can be actively controlled to maximize the temperature and melt overheat during the melting cycle.

In other embodiment, the coolant can be controlled to have a steady state flow in the cooling channels. For example, the cooling can be controlled in an on and off control manner with a steady flow when the control is on. In one embodiment, the cooling rate/effect can be controlled by turning off the flow of the coolant or removing the coolant from the cooling channels for a certain time duration during the melting cycle and allowing all meltable materials to heat up to a high temperature. When the temperature is increased and close to the wetting temperature T_{Wetting}, the cooling can be turned back on to reduce the temperature to keep it below the wetting temperature T_{Wetting}.

In embodiments, when the melt needs to be transferred to, e.g., atmosphere or a reactive environment, the cooling rate/effect can be increased after a certain point in the melting cycle to pull heat away from the system before the melt is transferred because the cooled meltable material may not interact with air or other reactive elements at the cooled low temperatures.

In an exemplary case where the skull layer has formed during the melting cycle, the cooling can be controlled to slow down or the cooling can be removed from the melting system such that, e.g., T_{Contact} can be increased and the skull layer can be melted.

Block 530b of FIG. 5b depicts another exemplary method for regulating contact temperature (T_{Contact}) at a maximum value but not exceeding T_{Wetting}. T_{Contact} can be compared with a wetting threshold temperature T_{Th-I}, wherein T_{Th-I}=T_{Wetting}−T_{sm-I}, T_{sm-I} is a temperature safety margin for T_{Wetting}, see FIG. 4b. T_{sm-I} can be determined by requirements of the melting system and process, materials used in the system (e.g., vessel material), meltable materials to be processed, efficiency in adjusting cooling rate/effect of the coolant, etc. As shown in FIG. 5b, if T_{Contact}>T_{Th-I}, the cooling system can be adjusted to increase cooling rate/effect at block 540b1, such that T_{Contact} can be reduced to be close or equal to T_{Th-I}. Likewise, if T_{Contact} is measured less than T_{Th-I}, the cooling system can be adjusted to decrease the cooling rate/effect at block 540b1, such that T_{Contact} can be increased to be close or equal to T_{Th-I}. By regulating the cooling rate/effect in the cooling channels, T_{Contact} can be a value close or equal to T_{Th-I}. The contact temperature T_{Contact} can be much higher than conventional temperature or can be maximized, but doesn't exceed the wetting temperature T_{Wetting}.

Block 530c of FIG. 5c depicts an additional exemplary method for regulating contact temperature (T_{Contact}) by comparing T_{Contact} with one or both of the wetting threshold temperature T_{Th-I} and a skull forming threshold temperature T_{Th-II}, wherein T_{Th-II}=T_{Skull}+T_{sm-II}, T_{sm-II} is a temperature safety margin for T_{Skull}, see FIG. 4c. T_{sm-II} can be determined by requirements of the melting system and process, materials used in the system (e.g., vessel material), meltable materials to be processed, efficiency in adjusting cooling rate/effect of the coolant, etc. At block 530c of FIG. 5c, T_{Contact} can be compared with T_{Th-II} and/or T_{Th-I} as shown in FIG. 4c. If T_{Contact}<T_{Th-II}, at block 540c1, the cooling system can be adjusted to decrease cooling rate/effect (including remove cooling) such that T_{Contact} can be increased to be more than T_{Th-II}. If T_{Contact}>T_{Th-I}, at block 540c2, the cooling system can be adjusted to increase the cooling rate/effect such that T_{Contact} can be decreased to be close or equal to T_{Th-I}. By regulating the cooling rate in the cooling channels, T_{Contact} can be controlled such that T_{Th-II}≦T_{Contact}≦_{Th-I}.

FIGS. 5a-5c can also have a feedback loop 550, wherein T_{Contact} is monitored or measured directly or indirectly and maintained at a temperature level as desired as shown in blocks 540, 540b1, 540b2, 540c1, 540c2 of FIGS. 5a-5c. The melt in the melting vessel can thus maintains at high temperatures with less heat loss before the melt is transferred, e.g., tilt poured or bottom poured from the vessel, to a casting machine to form an article.

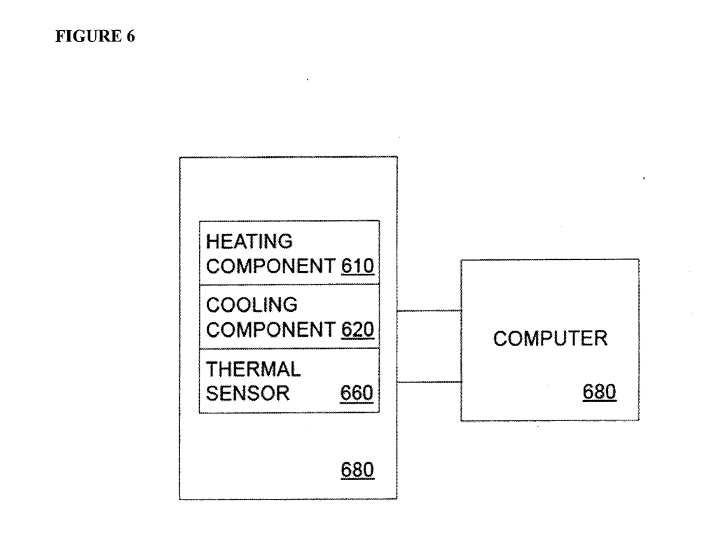

FIG. 6 depicts an apparatus 600 for active cooling regulation of a melting process in accordance with various embodiments of the present teachings. The apparatus 600 can include a melting system 680, for example, as shown in FIGS. 3a-3b and a computer 690.

The melting system 680 can include a heating component 610, a cooling component 620, and a thermal sensor 660.

The heating component 610 can include, for example, induction coils 330/330b to melt a meltable material 305/305b in the vessel 310/310b as shown in FIGS. 3a-3b.

The cooling component 620 can include, for example, one or more cooling channels 320/320b as shown in FIGS. 3a-3b, coolant, a cooling controller 625. The cooling controller 625 can be a device configured to control the cooling process, e.g., by controlling flow rate and/or flow time of the coolant, on and off control of the flow, etc.

The thermal sensor 660 can be used to directly or indirectly measure the contact temperature as disclosed herein. Therefore, the thermal sensor 660 can include, e.g., the thermal sensor 360/370 in FIG. 3a.

The computer 690 can be connected to any components in the melting system 680 and can be used to obtain raw data, to process data, to regulate the cooling process, to regulate contact temperature and/or to regulate the melting process.

In operation, active cooling regulation of a melting process can be performed using the apparatus in FIG. 6 in accordance with various methods, e.g., as depicted in FIGS. 4a-4c and 5a-5c. For example, when a meltable material is heated in the heating component 610, the contact temperature T_{Contact} can be measured by the thermal sensor 660. The data of T_{Contact} can be sent to the computer 690 and can be compared with T_{Skull}, T_{Wetting}, T_{Th-I}, and/or T_{Th-II} in the computer 690. Any known software can be used to process data. The computer can then send signal to the cooling controller 625 to adjust a cooling rate of the cooling component 620, according to the methods depicted in FIGS. 4a-c and 5a-5c.

While the invention is described and illustrated here in the context of a limited number of embodiments, the invention may be embodied in many forms without departing from the spirit of the essential characteristics of the invention. The illustrated and described embodiments, including what is described in the abstract of the disclosure, are therefore to be considered in all respects as illustrative and not restrictive. The scope of the invention is indicated by the appended claims rather than by the foregoing description, and all changes that come within the meaning and range of equivalency of the claims are intended to be embraced therein.

What is claimed is:

1. A method comprising:
heating a meltable material to form a melt in a vessel, wherein the vessel comprises at least one cooling channel;
comparing a contact temperature T_{Contact} of the vessel in contact with the melt with a skull temperature T_{Skull} and a wetting temperature T_{Wetting} of the melt in the vessel; and
regulating a cooling rate in the at least one cooling channel such that T_{Skull}<T_{Contact}<T_{Wetting} and the meltable material does not wet a surface of the vessel.

2. The method of claim 1, further comprising measuring the contact temperature T_{Contact}, wherein the measuring T_{Contact} comprises directly measuring the vessel at an interface with the melt.

3. The method of claim 2, wherein the measuring T_{Contact} comprises measuring a temperature of a coolant in the at least one cooling channel to determine T_{Contact}.

4. The method of claim 3, further comprising obtaining a look-up table relating the temperature of the coolant to T_{Contact}.

5. The method of claim 1, wherein the regulating the cooling rate comprises selecting a coolant, a flow rate, a flow time, or a combination thereof in the at least one cooling channel.

6. The method of claim 1, wherein the regulating the cooling rate comprises monitoring T_{Contact}, when heating, to slow down the cooling rate to inch up T_{Contact} to close to T_{Wetting}.

7. A method comprising:
heating a meltable material to form a melt in a vessel, wherein the vessel comprises at least one cooling channel;
comparing a contact temperature T_{Contact} of the vessel at an interface with the melt and a wetting threshold temperature T_{Th-I}, wherein T_{Th-I}=T_{Wetting}−T_{sm-I}, and T_{sm-I} is a temperature safety margin for T_{Wetting}; and
regulating a cooling rate in the at least one cooling channel such that T_{Contact} is a value close or equal to T_{Th-I}.

8. The method of claim 7, wherein the regulating the cooling rate comprises increasing the cooling rate to decrease T_{Contact} if the measured T_{Contact}>T_{Th-I}.

9. The method of claim 7, wherein the regulating the cooling rate comprises decreasing the cooling rate to increase T_{Contact} if the measured T_{Contact}<T_{Th-I}.

10. The method of claim 7, further comprising obtaining a look-up table relating the temperature of the coolant to T_{Contact}.

11. A method comprising:
heating a meltable material to form a melt in a vessel, wherein the vessel comprises at least one cooling channel;
comparing a contact temperature T_{Contact} of the vessel at an interface with the melt and one or both of a wetting threshold temperature T_{Th-I} and a skull forming threshold temperature T_{Th-II}, wherein T_{Th-I}=T_{Wetting}−T_{sm-I}, and T_{sm-I} is a temperature safety margin for T_{Wetting}, and wherein T_{Th-II}=T_{Skull}+T_{sm-II}, T_{sm-II} is a temperature safety margin for T_{Skull}; and
regulating a cooling rate in the at least one cooling channel such that T_{Th-II}≦T_{Contact}≦T_{Th-I}.

12. The method of claim 11, wherein the regulating the cooling rate comprises increasing the cooling rate to decrease T_{Contact} if the measured T_{Contact}>T_{Th-I}.

13. The method of claim 11, wherein the regulating the cooling rate comprises decreasing the cooling rate to increase T_{Contact} if the measured T_{Contact}<T_{Th-II}.

14. A melting system comprising:
a heating component configured to heat a meltable material in a vessel;
a cooling component comprising a cooling controller and a cooling channel, wherein the cooling channel is configured to flow a coolant therein; and
a thermal sensor configured to measure a contact temperature T_{Contact} at an interface between the heated meltable material and the vessel,
wherein the cooling controller is configured to regulate a cooling rate of the coolant by comparing the T_{Contact} with at least one temperature of the melt.

15. The system of claim 14, wherein the at least one temperature of the melt comprises a wetting temperature T_{wetting} of the melt, a skull forming temperature Lₛₖᵤₗₗ, a wetting threshold temperature T_{Th-I}, a skull forming threshold temperature T_{Th-II}, or combinations thereof.

16. The system of claim 14, wherein the cooling controller is configured to control a flow rate and a flow time of the coolant, a temperature of the coolant, an on and off control of the flow, and combinations thereof.

17. The system of claim 14, wherein the thermal sensor is configured to measure a temperature of the coolant.

18. An apparatus comprising:
a computer connected to a melting system, the melting system comprising:
a heating component configured to heat a meltable material in a vessel,
a cooling component comprising a cooling controller and a cooling channel,
wherein the cooling channel is configured to flow a coolant therein, and
a thermal sensor configured to measure a contact temperature T_{Contact} at an interface between the heated meltable material and the vessel,
wherein the computer is configured to compare T_{Contact} with one or more of a skull forming temperature T_{Skull}, a wetting temperature T_{Wetting}, a wetting threshold temperature T_{Th-I}, and a skull forming threshold temperature T_{Th-II} for regulating a cooling rate in the cooling channel.

19. The apparatus of claim 18, wherein the cooling controller is configured to control a flow rate and a flow time of the coolant, a temperature of the coolant, an on and off control of the flow, and combinations thereof.

20. The apparatus of claim 18, wherein the thermal sensor is configured within the vessel to measure the contact temperature T_{Contact}.
